(19) United States
(12) Patent Application Publication
(10) Pub. No.: US 2009/0017419 A1
(43) Pub. Date: Jan. 15, 2009

(54) Cannula for flushing a tooth root canal, and flushing device comprising the same

(76) Inventor: Ulrich Prager, Abstatt / Hattenbach (DE)

Correspondence Address: Factor & Lake;Micheal D Lake, 1327 W Washington Blv, Chicago, IL, 60607, US

(21) Appl. No.: 11/662,124

(22) PCT Filed: Aug. 30, 2005
(86) PCT No.: PCT/EP2005/009015

§ 371 Date: Feb. 12, 2008

(30) Foreign Application Priority Data
Sep. 7, 2004 (DE) 20 2004 014 051.9

(51) Int. Cl. A61C 5/02

(52) U.S. Cl. 433/81

(57) ABSTRACT

A cannula (20) is disclosed, for the flushing of narrow tooth root canals, the cannula tube (46) of which comprises an axially long opening (66) at the end thereof. The length of the opening (66) can in practice be about 7 mm.

The invention relates to a cannula for flushing a tooth root canal, and also to a tooth root-canal flushing device operating with such a cannula.

In order to free from residual tissue parts and contaminants the fine canals that arise in the course of preparing tooth roots, these canals are flushed with a treatment liquid by using cannulas. Treatment liquids of such a type include disinfecting agents but also agents that dissolve tissue, such as NaOCl.

If, for the purpose of cleaning tooth root canals, use is made of conventional cannulas, the wall of which is uninterrupted as far as the tip of the cannula, or in which the tip of the cannula exhibits only a small lateral window, it may happen that a high pressure builds up in the cannula when the treatment liquid is applied. By reason of this high pressure, in the case of very deep tooth root canals it is then not impossible that a web of tissue that is thinner only towards the interior of the jaw is penetrated by the treatment liquid under high pressure, and treatment liquid gets into the interior of the jaw. As a result of this, the jaw suffers lasting damage.

The present invention therefore aims to provide a cannula for flushing a tooth root canal is to be specified, by the use of which the danger of a high build-up of pressure within the cannula is reduced.

This object is achieved by a cannula with the features specified in claim 1.

The long axial window at the free end of the cannula tube ensures that high pressure is unable to build up within the cannula tube. Despite this axial window, it has been found that the treatment fluid is also able to reach the bottom of the tooth root canal reliably, since the treatment fluid in the cannula tube is able to flow at great speed, inasmuch as no high counterpressure is built up in the cannula tube.

The end section of the cannula tube which is opened by the long axial window consequently acts as a channel which conducts the jet of treatment fluid to the end of the canal, but does not act as a pressure-resistant tube.

Advantageous further developments of the invention are specified in the dependent claims.

The further development of the invention according to claim 2 is advantageous with regard to a smooth routing of the treatment fluid as far as the lowest point of the tooth root canal. In addition, by virtue of the measure specified in claim 2 the displacing cross-section of the material of the cannula tube is reduced at the free end, so that said tube can be pushed well in as far as the apex of the tooth root canal without applying major force.

An axial extent of the window provided in the cannula tube such as is specified in claim 3 has proved to be particularly good in practice. In this way, the build-up of high pressures in the cannula tube is reliably avoided, and at the same time it is ensured that the treatment liquid is still conducted right to the end of the tooth root canal. Cannulas that exhibit the dimensions of the window that are specified in claim 3 can be used in a standard size for flushing the tooth root canals of most patients.

The further development of the invention according to claim 4 is also advantageous with regard to effective avoidance of a build-up of pressure in the cannula tube, on the one hand, and effective conducting of the treatment fluid right to the end of the tooth root canal, on the other hand.

A window that is situated in a plane which is spaced from the axis of the cannula tube, as specified in claim 5, can be generated in a particularly straightforward manner by grinding a cannula tube.

Diameters of the cannula tube such as are specified in claim 6 are advantageous with regard to adequate mechanical stability in the course of flushing, on the one hand, and flexibility of the cannula, as is desirable for ergonomic working, on the other hand.

For the same reasons, the wall thicknesses for the cannula tube that are specified in claim 7 are preferred.

Cannulas according to claim 8 are distinguished by good flexibility with, at the same time, good stability under the forces acting on them in the course of flushing.

With a cannula according to claim 9, the complementary coupling piece that interacts with the cannula connecting piece has a larger dimension than coupling pieces such as are used with conventional cannulas. Hence the possibility is excluded that conventional cannulas are also attached to the coupling piece of a handpiece that provides the treatment fluid for the tooth root-canal treatment. Standard cannulas of such a type, which would possibly be preferred by users for reasons of cost, would entail the danger described in the introduction, namely that a high pressure builds up in the cannula tube and treatment liquid is forced into the interior of the jaw.

As explained above, with the cannula according to the invention a reliable supply of treatment fluid is obtained also at the end of the tooth root canal despite the axial window in the end section of the cannula tube, since the treatment fluid is conveyed through the cannula tube at relatively high speed and also retains this speed in the region of the axial window. But fluids moving rapidly result in splashes when they strike hard obstacles. Such splashes are undesirable in the case of aggressive media such as NaOCl, both with regard to undesirable etching effects in the oral cavity and with regard to damage to the clothing of the patient and of the dentist.

If use is made of a cannula with an associated splash guard as specified in claim 10, treatment liquid emerging from the tooth root canal is held back at the tooth itself.

With the further development of the invention according to claim 11, it is guaranteed that treatment fluid emitted from the tooth root canal strikes the splash guard in any case.

The further development of the invention according to claim 12 is advantageous with regard to the use of the splash guard in connection with variably-sized teeth of different patients.

The further development of the invention according to claim 13 enables treatment fluid emerging from the tooth root canal, which is held back by the splash guard, to be conducted away continuously in controlled manner.

The further development of the invention according to claim 14 is advantageous with regard to simple ease of handling of the back-suction device for consumed treatment fluid, which is constituted by splash guard and suction hose.

In this connection, a splash guard according to claim 15 is particularly well-suited for use with suction hoses exhibiting a circular cross-section.

With a cannula according to claim 16, it is guaranteed that the back-suction of consumed treatment fluid is effected in the immediate vicinity of the cannula.

With a flushing device according to claim 17, a greater volume is sucked back out of the tooth root canal than corresponds to the volume of the cannula tube. Consequently, treatment fluid is also sucked back out of the tooth root canal itself, and portions of air are then admixed to this treatment fluid.

In the buffer chamber of the flushing device a mixture consisting of air and treatment liquid is consequently formed. Before the next flushing cycle, a predetermined supplementary quantity of treatment liquid is then supplied to this mixture before the mixture then obtained in this way is rapidly pressed back again into the tooth root canal through the cannula.

By virtue of the mixing of air and treatment liquid so as to form a foam-like treatment fluid, on the one hand a better utilisation of the treatment fluid is obtained, but, on the other hand, also a better wetting of the surface of the tooth root canal.

The desired high flow speeds in the canal tube are obtained particularly well if the times for the emission of treatment fluid from the buffer chamber of the flushing device that are specified in claim 18 are complied with.

The invention will be elucidated in more detail in the following on the basis of an exemplary embodiment with reference to the drawing. Shown in the latter are:

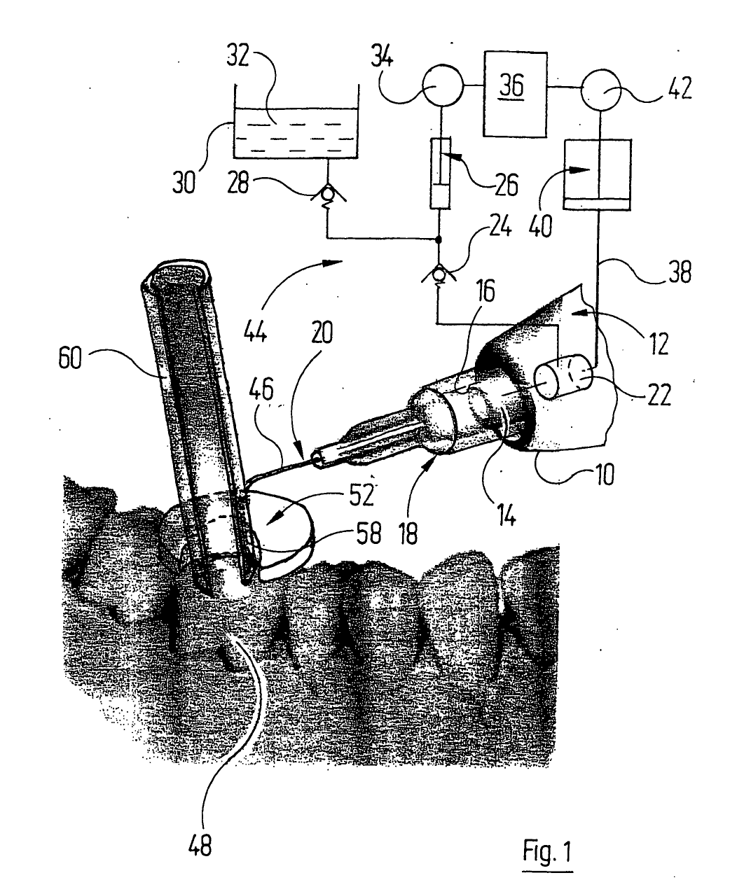

FIG. 1: the end section of a root-canal flushing device with attached flushing cannula, with a splash guard and with a suction-extraction hose for consumed treatment fluid, a unit for the intermittent provision and back-suction of treatment fluid being illustrated schematically in the form of a block diagram;

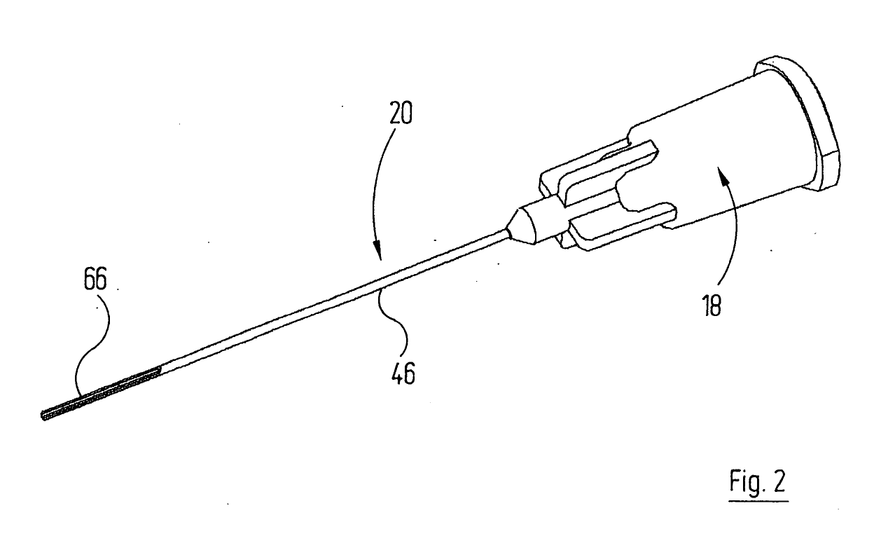

FIG. 2: an enlarged perspective view of a flushing cannula;

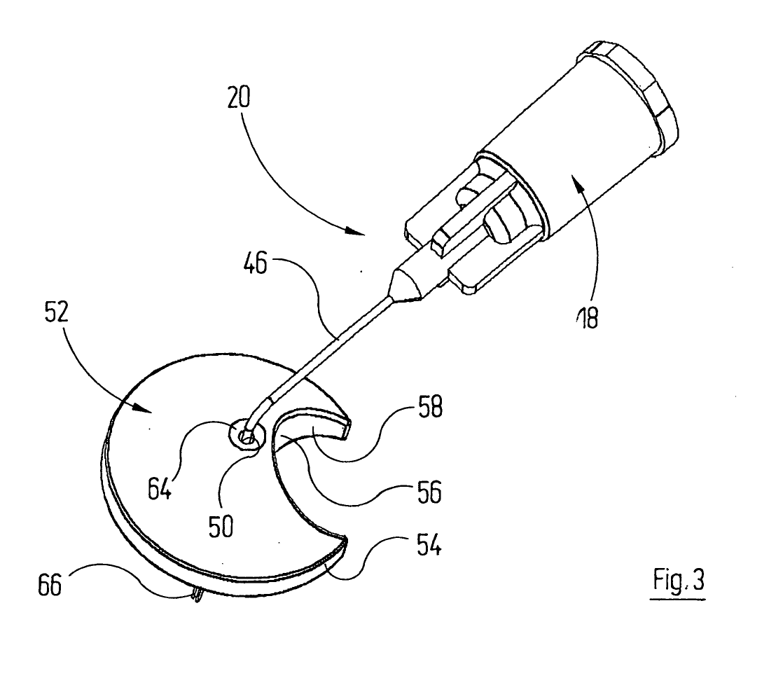

FIG. 3: a perspective view of the unit constituted by cannula and splash guard, obliquely from above;

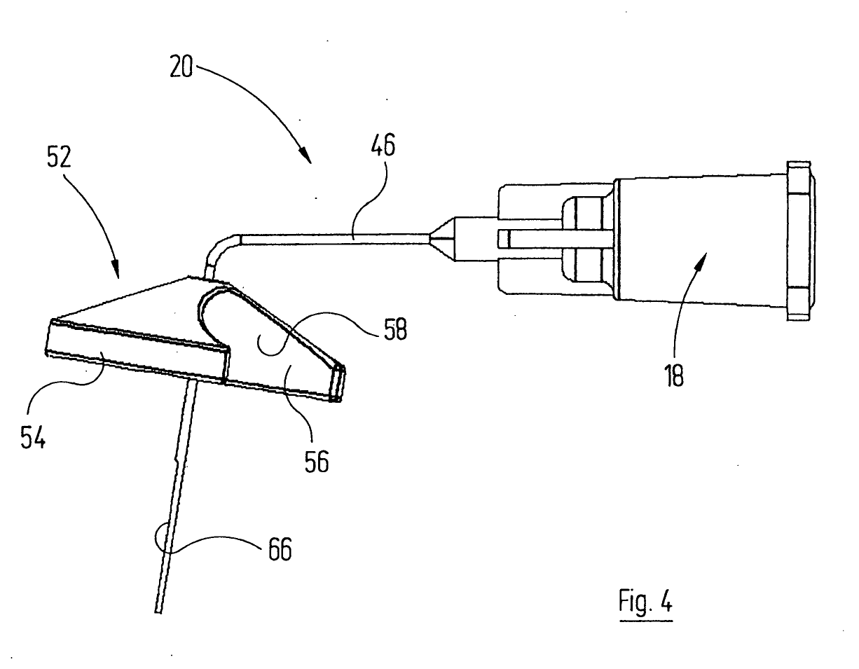

FIG. 4: a side view of the unit constituted by cannula and splash guard;

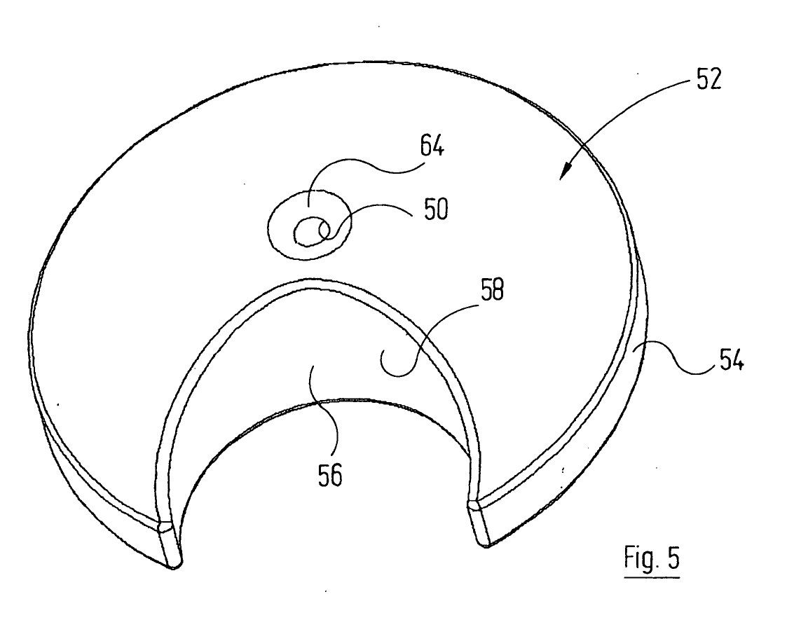

FIG. 5: an enlarged perspective view of a splash guard shown in FIG. 1;

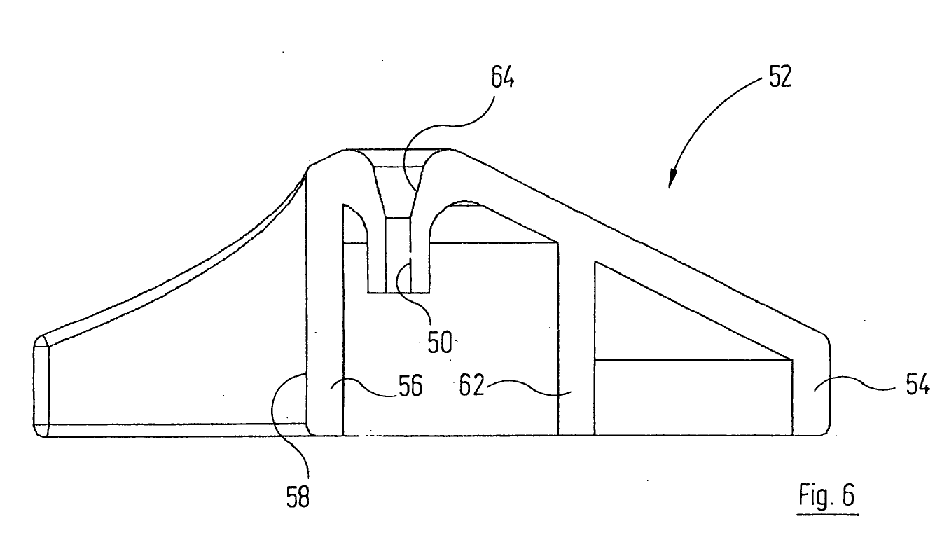

FIG. 6: an axial section through the splash guard according to FIG. 4; and

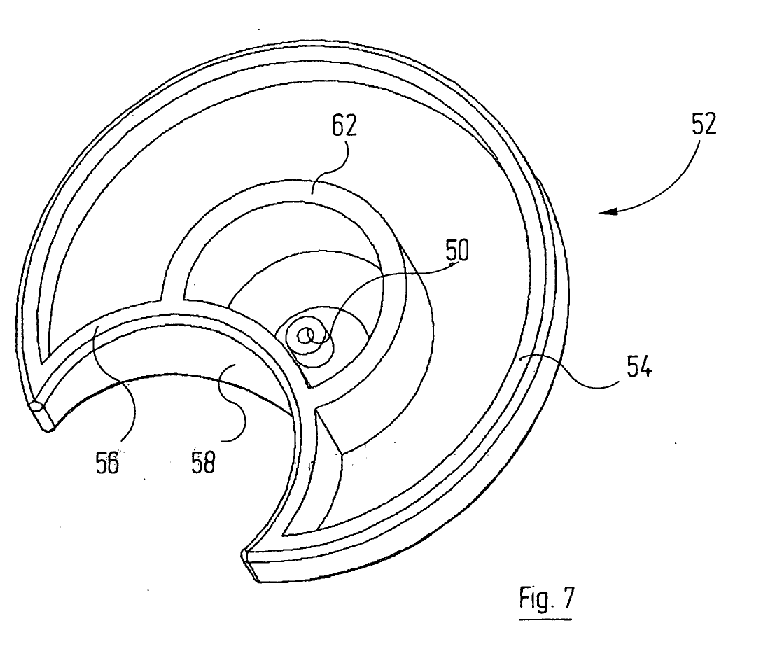

FIG. 7: a perspective view of the splash guard, viewed obliquely from below.

In FIG. 1 the treatment-side end section of a tooth root-canal flushing device which is designated overall by 12 is represented at 10. The end section 10 exhibits a coupling adapter 14 which interacts with a coupling bore 16 which interacts in a connecting piece 18 of a cannula which is designated overall by 20, in order to form a fluid plug-and-socket connection.

In the end section 12 a mixing chamber 22 is formed, which is connected to the delivery side of a feed pump 26 via a check valve 24. The pump aspirates, via a second check valve 28, from a storage container 30 which holds a volume of a treatment liquid 32 which, for example, may be an NaOCl solution or a disinfecting agent.

The feed pump 26 is moved back and forth by a motor 34 which may be a compressed-air motor or an electric motor and which, in turn, is controlled from a control unit 36. The coupling adapter 14 is connected via a line 38 to a pump 40 which is driven by a motor 42, which again may be a compressed-air motor or an electric motor and which is likewise controlled from the control unit 36.

The components 24 to 42 described above constitute a supply unit which is designated overall by 44.

A cannula tube 46, which is supplied by the factory in straight geometry and which is bent by the dentist into the required shape in the given case, is carried by the connecting piece 18 of the cannula 20. In FIG. 1 the cannula tube 46 is shown bent by 90° and has been introduced into a prepared tooth root canal which has been formed in a tooth 48.

The angled section of the cannula tube 46 is guided through a central cannula opening 50 (see FIG. 3) in a splash guard 52.

The upper side of the splash guard 52 is substantially conical, with the aperture angle of the cone amounting to approximately 120°, as is evident from FIG. 4. The splash guard 52 has an outer peripheral wall 54 which is moulded onto the outer rim of the wall of the cone.

A further partially cylindrical wall 56 of the splash guard 52 delimits a circular rim recess 58 which under operational conditions is able to accommodate a suction hose 60, as represented in FIG. 1.

At approximately one half of the radial extent of the splash guard 52 a further partially cylindrical wall 62 is provided extending in the peripheral direction. The free edges of the walls 54, 56 and 62 are situated in a common plane, as FIG. 4 shows.

As is likewise evident from FIG. 4, the cannula opening 54 has a cup-shaped upper opening section 64 which facilitates introduction of the end of the cannula.

As is evident from FIG. 1, the splash guard 52 has a diameter of such a size that it projects radially from a large buccal tooth. The splash guard 52 may equally be affixed to teeth of greater and smaller diameter. In practice, its diameter amounts to approximately approximately 8 mm to 12 mm, preferably approximately 9 mm to 11 mm.

The splash guard 52 is a one-piece plastic injection moulding which may be a disposable part or which may be an autoclavable, repeatedly-usable part.

As is evident from FIG. 2, at its free end the cannula tube 46 has a long axial window 66 which was obtained by transverse, plane abrading of material. The edge of the window is situated in a plane that is spaced in the upward direction from the axis of the cannula tube 46.

In practice, the cannula tube has a diameter of 0.45 mm in the case of a wall thickness of 0.1 mm. The material from which the cannula tube 46 is manufactured is a 1.4301 steel material.

The spacing of the plane of the window from the axis of the cannula tube amounts to approximately 0.05 mm, as a result of which an aperture angle of the window, relative to the axis of the cannula tube, of approximately 175° arises.

In a practical exemplary embodiment the axial dimension of the window 66 amounts to 7 mm. Dimensions down tos 5 mm and up to 9 mm are also very well-suited for special lengths of tooth root canal.

By virtue of the fact that the window 66 exhibits a greater axial dimension, it is guaranteed that no appreciable pressure is able to build up within the cannula tube 46, even when the cannula tube 46 has been introduced into a narrow tooth root canal. Although the cannula tube 46 is consequently open laterally over a relatively large distance, the treatment fluid supplied through the cannula tube 46 also gets as far as the end of the tooth root canal reliably, since it crosses the open tube section at relatively high speed.

The connecting piece 18 of the cannula 20 is again a plastic injection moulding, in which the feed-side end of the cannula tube 46 is co-embedded in the course of injection moulding.

As explained above, in the end section 18 the mixing chamber 22 is formed which merges with the coupling adapter 14 in the direction towards the connecting piece 18.

In the cannula that is of interest here, the coupling bore 16 is larger than in the standard cannulas which are used in conjunction with disposable syringes. Correspondingly, the coupling adapter 14 also has a larger diameter. Hence standard cannulas cannot be attached to the coupling adapter 14. This is important, for the reason that cannulas of such a type, when introduced into a narrow tooth root canal, would have a tendency to become blocked, from which the danger described in the introduction would arise, namely a high build-up of pressure within the cannula and the penetration of the treatment medium into the interior of the jaw.

The treatment device described above operates in the following way:

In a first cycle, the motor 34 is firstly driven by the control unit 36 in such a way that liquid previously aspirated out of the feed pump 26 is forced into the mixing chamber 22 via the check valve 24. Then the motor 42 is activated by the control unit 36, and the pump 44 forces the contents of the mixing chamber 22 into the cannula tube 46.

From the end of the cannula tube, the supplied medium is delivered to the tooth root canal without a relatively high pressure building up in the cannula tube 46. This is to be ascribed to the long axial window 66, as described above.

The supplied treatment medium is introduced into the tooth root canal at relatively high speed on account of correspondingly rapid actuation of the pump 40, and the liquid reflected at the walls of said canal is discharged in part through the upper open end of the tooth root canal in the form of splashes. The latter are held back by the underside of the splash guard 52 which is attached to the upper side of the tooth 48.

At the same time, the suction hose 60 is subjected to a reduced pressure, and liquid collecting on the surface of the tooth 48 is removed.

After this feed cycle, the motor 42 is activated by the control unit 36 in such a way that aspiration by the pump 40 from the inside of the cannula tube 46 takes place.

The activation-time and the delivery capacity of the pump 40 are such that a multiple of the volume of medium that was emitted to the tooth root canal in the feed phase is sucked back out therefrom within the activation-time of the pump 40. Consequently, together with treatment liquid that is still present in the cannula tube 46, treatment liquid is aspirated from the lower end of the tooth root canal, and, in addition to this, a considerable volume of air. In the pumping phase, a mixture consisting of treatment liquid and air consequently arrives in the mixing chamber 22, which is retained there until the start of the next pumping cycle.

The motor 34 is now activated again by the control unit 36 in such a way that a supplementary quantity of treatment liquid reaches the mixing chamber 22. In the mixing chamber, and upon subsequent expulsion of the contents of the mixing chamber into the cannula tube 46, said treatment liquid mixes with the mixture contained in the mixing chamber and consequently forms a treatment fluid that is a mixture of treatment liquid and air. Said treatment fluid is forced into the cannula tube 46 again by the pump 40.

The treatment cycles are short. In practice, the flushing device 12 operates at a frequency of approximately 1-2 Hz, preferably approximately 1.6 Hz.

By appropriate programming of the control unit 36, it is ensured that the pumping cycle is shorter than the suction cycle, so that a high flow speed of the treatment fluid supplied to the tooth root canal is obtained.

Overall, the actuation-times and the delivery-rates of the pumps are chosen in such a way that for each pumping cycle a supply of treatment liquid in an amount of approximately 60-70 μl, preferably approximately 65 μl, is obtained, and the quantity of fluid pumped back per suction cycle amounts to approximately 120-140 μl, preferably approximately 130 μl.

In this connection the dead volume constituted by the inside of the cannula tube 46 amounts to 10 μl.

Hence a consumption of treatment liquid within the range from approximately 5 ml to approximately 7 ml per minute arises overall. These quantities guarantee an effective and active flushing and, in the case where use is made of tissue-ablating treatment liquids such as NaOCl, the desired removal of residual tissue.

By virtue of the flushing device described above, in which the cannula does not have a tendency to become blocked, a very thorough cleaning of the tooth root canal is also obtained. In tooth-root treatments there is always a great danger of inflammations forming after the tooth root canal has been filled, since parts of the prepared surface still carry germs. Renewed treatments which become necessary are not uncommon and are associated with further pain and further cost for the patient.

1. A cannula for flushing a tooth root canal, with a cannula tube which is carried by a connecting piece, wherein the cannula tube exhibits at its free end an axial window that is long, compared with the diameter of the cannula.

2. The cannula of claim 1, wherein the axial window extends right up to the end face of the cannula tube.

3. The cannula of claim 1 wherein the axial extent of the window amounts to 5-9 mm.

4. The cannula of claim 1, wherein, the window exhibits a peripheral extent of approximately 160-180°.

5. The cannula of claim 4, wherein the window is situated in a plane extending parallel, with a spacing from the axis of the cannula tube that is small, compared with the diameter of the cannula tube.

6. The cannula of claim 1, wherein the cannula tube exhibits a diameter of approximately 0.3-0.6 mm.

7. The cannula of claim 1, wherein the cannula tube exhibits a wall thickness of approximately 0.05-0.15 mm.

8. The cannula of claim 6, wherein the cannula tube is manufactured from 1.4301 steel.

9. The cannula of claim 1, wherein the connecting piece exhibits a coupling bore, the diameter of which is larger than the diameter of the coupling bore of standard cannulas.

10. The cannula of claim 1, further comprising a substantially disc-shaped splash guard which exhibits a cannula opening through which the cannula tube is capable of being guided.

11. The cannula of claim 10, wherein the splash guard is larger than the masticatory surface of a buccal tooth.

12. The cannula of claim 11, wherein the splash guard exhibits a circular rim, the diameter of which amounts to approximately 8-12 mm.

13. The cannula of claim 10, wherein the splash guard exhibits a recess in which a suction hose is capable of being arranged.

14. The cannula of claim 13, wherein the recess is open in the direction towards the rim of the splash guard.

15. The cannula of claim 13 wherein the rim contour of the opening in which the suction hose is capable of being arranged is circular.

16. The cannula of claim 13, wherein the radially innermost section of the opening in which a suction hose is capable of being arranged exhibits a spacing from the cannula-receiving opening that corresponds, in order of magnitude, to the diameter of the cannula-receiving opening or amounts to a small multiple of the same.

17. A device for flushing a tooth root canal, with the cannula of claim 1 and also with a supply unit which intermittently emits small volumes of treatment fluid to the cannula and subsequently sucks treatment fluid back out of the cannula, wherein treatment fluid that has been sucked back being stored in a buffer chamber for later re-emission to the cannula in a following feed cycle, and further wherein the volume of the buffer chamber amounts to a multiple of the volume of the cannula tube and in that the quantity of fluid sucked back is greater than the quantity of treatment fluid emitted.

18. The device of claim 17, wherein the periods of time within which the contents of the buffer chamber are emitted to the cannula amount to approximately 0.1-0.8 second.

19. The device of according to claim 17, wherein the phase of an operating cycle within which treatment fluid is supplied to the cannula is shorter than the phase of the cycle in which fluid is sucked back out of the cannula.
